(19) United States
(12) Patent Application Publication
(10) Pub. No.: US 2025/0292370 A1
(43) Pub. Date: Sep. 18, 2025

(54) VIDEO RECTIFICATION FOR FRAMES HAVING CAMERA INTRODUCED DISTORTION

(71) Applicant: QUALCOMM Incorporated, San Diego, CA (US)

(72) Inventors: Shivansh Rao, San Diego, CA (US); Varun Ravi Kumar, San Diego, CA (US); Arunkumar Nehrur Ravi, San Diego, CA (US); Senthil Kumar Yogamani, Headford (IE)

(21) Appl. No.: 18/607,091

(22) Filed: Mar. 15, 2024

(51) Int. Cl. G06T 5/60; G06T 5/70; G06T 5/80; G06T 7/00; G06V 10/40

(52) U.S. Cl. CPC G06T 5/60; G06T 5/70; G06T 5/80; G06T 7/0002; G06T 2207/10016; G06T 2207/20081; G06T 2207/20084; G06T 2207/30168; G06V 10/40

(57) ABSTRACT

A system for video rectification includes processing circuitry configured to: apply a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame; determine parameters for the video correction model based on at least one of a difference between the current rectified frame and one or more previous rectified frames and a difference between the current rectified frame and the current distorted frame; and update the video correction model based on the parameters.

### TECHNICAL FIELD

This disclosure relates to frame correction in camera systems.

### BACKGROUND

Fisheye cameras are specialized lenses or camera systems designed to capture an extremely wide-angle view, often exceeding 180 degrees. Fisheye cameras may be used for several autonomous driving perception tasks, such as object detection, object tracking, and other tasks because of the wider field of view (FOV) that fisheye cameras provide.

Fisheye cameras are named due to the distorted, spherical perspective that fisheye cameras produce, which is similar to the perspective through eyes of a fish. Accordingly, the image content produced by fisheye cameras are usually rectified for performance.

### SUMMARY

In general, this disclosure describes techniques for using a video correction model, such as a spatio-temporal denoising diffusion model, to correct for distortion in frames introduced by cameras that capture the frames. For instance, processing circuitry may apply the video correction model to a current distorted frame (e.g., captured by a fisheye camera) that applies a forward diffusion process of adding noise to the current distorted frame (e.g., to extracted features of the current distorted frame), and a reverse diffusion process of denoising. The reverse diffusion process is based on the added noise, as well as information from one or more previous distorted frames (e.g., information from extracted features of one or more previous distorted frames having noise added to the extracted features).

For instance, the processing circuitry may use the video correction model to learn distortion patterns implicitly through a noise corruption and denoising process applied to the extracted features (also referred to as the latent space) of input frames. The video correction model accounts for content within the current frame, as well as content within previous frames to ensure both spatial and temporal coherence. In some examples, by enforcing consistency losses, the model may be trained in a self-supervised manner to generate a rectified video output with coherent frames that are spatially and temporally consistent with the input frames. The consistency losses may be the difference between two rectified frames and/or difference between a rectified frame and it distorted frame. In this manner, the example techniques may generate video image content having less distortion, as compared to other techniques.

In one example, the disclosure describes a system for video rectification, the system comprising: one or more memories; and processing circuitry coupled to the one or more memories and configured to: apply a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame; determine parameters for the video correction model based on at least one of a difference between the current rectified frame and one or more previous rectified frames and a difference between the current rectified frame and the current distorted frame; and update the video correction model based on the parameters.

In one example, the disclosure describes a method of video rectification, the method comprising: applying a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame; determining parameters for the video correction model based on at least one of a difference between the current rectified frame and one or more previous rectified frames and a difference between the current rectified frame and the current distorted frame; and updating the video correction model based on the parameters.

In one example, the disclosure describes a computer-readable storage medium storing instructions thereon that when executed cause one or more processors to: apply a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame; determine parameters for the video correction model based on at least one of a difference between the current rectified frame and one or more previous rectified frames and a difference between the current rectified frame and the current distorted frame; and update the video correction model based on the parameters.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example system according to techniques of this disclosure.

FIG. 2 is a block diagram illustrating an example video correction model.

FIG. 3 is a flowchart illustrating an example method of operation.

FIG. 4 is a flowchart illustrating another example method of operation.

### DETAILED DESCRIPTION

In autonomous driving (AD) systems, autonomous driving assistance systems (ADAS), or other systems used to partially or fully autonomously control a vehicle, cameras of the vehicle capture frames that processing circuitry processes for various post-processing purposes such as object detection or object tracking. In systems other than AD systems, such as virtual reality (VR), augmented reality (AR), etc. (generically referred to as XR), the processing circuitry may be similarly configured to receive frames captured by cameras and perform post-processing for object detection or object tracking.

In one or more example systems, the cameras used to capture the frames introduce distortion to the frames. For instance, fisheye cameras capture an extremely wide-angle view, often exceeding 180 degrees, but generate distorted, spherical frames in which the image content is distorted.

This disclosure describes machine learning (ML) based techniques to rectify the distortion in the frames. For instance, the disclosure describes a video correction model, which is a ML based model.

In this disclosure, the term “machine learning” is used generically to refer to systems that learn and adapt. For instance, machine learning is used generically to refer to artificial intelligence (AI), neural network, the various types of neural networks (e.g., convolutional neural network, feed forward neural network, etc.), and machine learning techniques used for image generation, such as neural radiance fields (NeRF) neural networks. Moreover, the example techniques may utilize various techniques for training, such as generative adversarial network (GAN) or PatchGAN. The use of the term machine learning model or ML model includes the various trained models that are generated using the example ML techniques, and the techniques should not be considered limited to the above examples. Also, the training of the ML model may be performed by example techniques such as GAN or PatchGAN, but the techniques should not be considered limited.

As described in more detail, the video correction model utilizes a diffusion-based approach to rectify a current distorted frame to generate a current rectified frame. The distortion in the current distorted frame may be introduced by the camera. For instance, the current distorted frame may be a current fisheye frame, and the camera may be a fisheye camera.

The diffusion-based approach includes a forward diffusion process to introduce noise to a current distorted frame, along with a reverse diffusion process to denoise. In one or more examples, the input of the reverse diffusion process includes combining information generated during the forward diffusion process of one or more previous distorted frames (e.g., distorted frame captured prior to the current distorted frame) with the output of the forward diffusion process of the current distorted frame. The combining may also include combining the current distorted frame (e.g., extracted features of the current distorted frame) with the information generated during the forward diffusion process of one or more previous distorted frames and the output of the forward diffusion process of the current distorted frame.

In this manner, by combining the output of the forward diffusion process of the current distorted frame and the information generated during the forward diffusion process of previous distorted frames as the input of the reverse diffusion process, the video correction model accounts for temporal variation (e.g., inter-frame changes) to maintain temporal coherency across frames. Furthermore, by also combining the current distorted frame (e.g., extracted features of the current distorted frame) as part of the reverse diffusion process, the video correction model accounts for spatial variation (e.g., intra-frame changes) to maintain spatial coherency across frames.

The result of applying the video correction model may be a current rectified frame. The current rectified frame may be better suited for post-processing, such as object detection/object tracking, as compared to the current distorted frame. The current rectified frame may also be better suited for display to a viewer, as compared to the current distorted frame.

In one or more examples, the video correction model is a self-supervised model. For instance, rather than using voluminous amount of training data to generate a trained video correction model, the processing circuitry applying the video correction model may determine a consistency loss, such as a difference between a current rectified frame and one or more previous rectified frames and/or a difference between a current rectified frame and a current distorted frame. The processing circuitry may then use the consistency loss to update parameters of the video correction model (e.g., weights and offsets of the reverse diffusion process).

Accordingly, the example techniques described in this disclosure maintain spatial and temporal coherency across frames that are used to form a video sequence. For instance, some techniques provide frame rectification on a per-frame basis. However, such techniques fail to efficiently capture temporally coherent output across the video sequence. Moreover, the self-supervised nature of the video correction model enables the video correction model to be robust and applicable to different use cases. The distortion caused by fisheye cameras can be different for different use cases, especially with different camera setups. The self-supervised nature of the video correction model enables training of the video correction model without voluminous training data, such as many ground truth frames, for different uses cases. In this manner, the video correction model is usable for different types of distortions, different camera setups, and generally for different use cases with minimal training overhead.

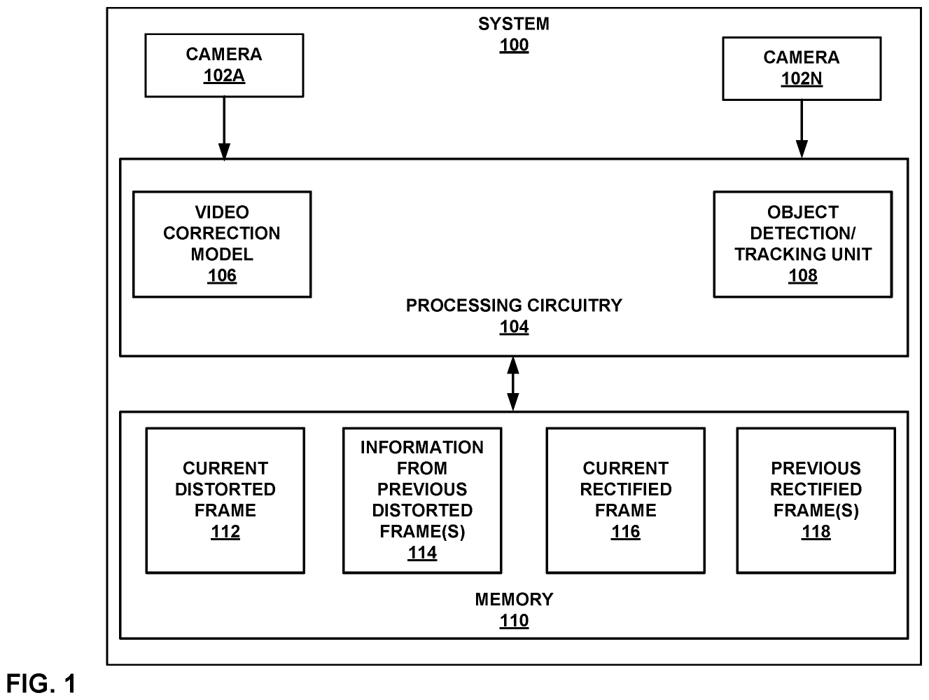

FIG. 1 is a block diagram illustrating an example system 100 according to techniques of this disclosure. Examples of system 100 include a vehicle, a virtual reality, augmented reality, etc. (i.e., XR) device, such as a XR headset, a camera system, etc. System 100 should not be considered limited to the above examples.

In this example, system 100 includes cameras 102A-102N, processing circuitry 104, and memory 110. Processing circuitry 104 may be configured to execute video correction model 106, and be configured to perform object detection and/or object tracking with object detection/tracking unit 108 using the output from video correction model 106. Object detection and object tracking are merely provided as examples, and should not be considered limiting. In some examples, system 100 may include a display, and the display may display the output from video correction model 106. In such examples, object detection and objection tracking may not be necessary, but it is possible that object detection/tracking unit 108 performs object detection and/or object tracking even in such examples.

Processing circuitry 104 may be formed in one integrated circuit (IC) or formed across may different ICs. Processing circuitry 104 may be located completely within one device (e.g., a vehicle, XR headset, or camera unit), as illustrated, or distributed between different components (e.g., servers in a cloud, etc.). For ease of description only, processing circuitry 104 is described as being part of one device. However, processing circuitry 104 should not be considered as being limited to examples where processing circuitry 104 is wholly or partially included in one device.

Processing circuitry 104 may be implemented as one or more microprocessors, digital signal processors (DSPs), application specific integrated circuits (ASICs), field programmable gate arrays (FPGAs), discrete logic, software, hardware, firmware or any combinations thereof. Processing circuitry 104 may include arithmetic logic units (ALUs), elementary function units (EFUs), digital circuits, analog circuits, and/or programmable cores, formed from programmable circuits. In examples where the operations of processing circuitry 104 are performed using software (e.g., ML models) executed by the programmable circuits, memory 110 may store the instructions (e.g., object code) of the software that processing circuitry 104 receives and executes, or another memory (not shown) may store such instructions.

There may be a plurality of cameras 102A-102N (collectively cameras 102), but more or fewer cameras, including only one camera is possible. In one or more examples, cameras 102 may introduce distortion into frames that cameras 102 capture. For example, cameras 102 may be fisheye cameras, and the image content of frames captured by cameras 102 may include distortion but provide wide viewing angle.

The type of cameras 102 may be different for different use cases. For example, for vehicle use, cameras 102 may provide a wider coverage around the car, where cameras 102 on the rear of the vehicle are fisheye cameras (e.g., cameras having fisheye lenses). For vehicles, there may be a greater number of cameras 102 as compared to other uses cases, such as XR. For XR, the distortion from cameras 102 is usually a circular fisheye patter with barrel distortion.

For both vehicle and XR, the overall pipeline of image processing is similar. That is, object detection/tracking unit 108 may perform similar 3D/2D operations for both vehicle and XR use cases to generate information that an assist with safety (e.g., path planning for vehicles or boundary setting in gaming with XR headset).

Object detection/tracking unit 108 may perform object detection and/or object tracking using any of a variety of techniques. For instance, object detection/tracking unit 108 may be a ML model that processing circuitry 104 executes. As one example, object detection/tracking unit 108 may be a CNN (convolutional neural network) with feature extractors and classifiers used for object detection and tracking. The example techniques described in this disclosure should not be considered limited to any particular manner in which object detection/tracking unit 108 operates.

However, since the type of fisheye lens, camera setup, distortion patterns, etc. can be different for the different use cases, some techniques may not be scalable or extensible for rectifying distortion in all the different uses cases. In one or more examples described in this disclosure, video correction model 106 may be configured to rectify distortion in frames introduced by cameras 102 independent of the specific use case. For instance, as explained in more detail, video correction model 106 may be a self-supervised diffusion-based model which enables rectifying distortion without voluminous training data that is specific to the use cases, and while accounting for temporal and spatial changes to ensure temporal and spatial coherency across frames.

Memory 110 may be formed by any of a variety of memory devices, such as dynamic random access memory (DRAM), including synchronous DRAM (SDRAM), magnetoresistive RAM (MRAM), resistive RAM (RRAM), ROM, EEPROM, or other types of memory devices. Memory 110 may store object code of video correction model 106 that processing circuitry 104 retrieves and executes.

Memory 110 may also store current distorted frame 112, information from one or more previous distorted frames 114, current rectified frame 116, and one or more previous rectified frames 118. Current distorted frame 112 refers to a current frame captured with one of cameras 102 (e.g., the distorted frame as output from one of cameras 102), where the distortion is introduced by that one of cameras 102. As described in more detail, information from one or more previous distorted frames 114 refers to information generated from video correction model 106 when the one or more previous distorted frames were being processed using video correction model 106.

Current rectified frame 116 refers to the output of video correction model 106 from the rectification of the distortion of current distorted frame 112. In one or more examples, object detection/tracking unit 108 may utilize for object detection and/or object tracking. One or more previous rectified frames 118 refer to results from rectification of distorted frames captured by one of cameras 102 before current distorted frame 112 is captured.

As described above, video correction model 106 may be self-supervised diffusion-based model that provides temporal and spatial coherency across frames. The term “self-supervised” refers to video correction model 106 needing limited to ground truth data, and instead being trained based on frames captured during runtime. Sufficient ground truth data for different distortion levels and camera setups to train video correction model 106 is expensive and generally not available. Hence, the “self-supervised” capability of video correction model 106 enables video correction model 106 to be scalable and extensible for different use cases that is robust to diverse distortion patterns seen in real-world scenarios and does not rely on external calibration data, lens information (e.g., fisheye lens information), or camera setup.

The term “temporal coherency” refers to image content across frames appearing accurately. For instance, moving objects across frames should appear in different locations within the frames, while static objects should appear at the same location within the frames to maintain temporal coherency. The term “spatial coherency” refers to image content within a frame appearing accurately relative to other image content within the frame. For instance, as part of the rectification process, an object within the frame should appear an accurate distance away from another object, and properly reflect the real-world distances between the objects to maintain spatial coherency.

The term “diffusion-based” refers to ML techniques that rely on noise corruption and denoising process. One example of the diffusion-based techniques include the learning distortion patterns implicitly through a Markov chain process. The diffusion-based techniques includes a forward diffusion process and a reverse diffusion process, described in more detail below.

Video correction model 106 being a self-supervised diffusion-based model that provides temporal and spatial coherency across frames is provided as an example, and should not be considered limiting. For instance, in some examples, video correction model 106 may provide temporal coherency but not necessarily spatial coherency. In some examples, video correction model 106 may provide spatial coherency but not temporal coherency. Video correction model 106 may also not be fully self-supervised, and may rely on various amounts of training data. That is, video correction model 106 may be trained with available training data, and then may be updated during runtime with runtime data. Moreover, techniques other than diffusion-based models are possible as well.

In general, processing circuitry 104 applies video correction model 106 to current distorted frame 112 to generate current rectified frame 116. In one or more examples, information from one or more previous distorted frames 114 is input to video correction model 106. That is, processing circuitry 104 applies video correction model 106 to current distorted frame 112 based on information from one or more previous distorted frames 114 to generate current rectified frame 116. In one or more examples, processing circuitry 104 applies video correction model 106 to current distorted frame 112 based on information from one or more previous distorted frames 114 and information from current distorted frame 112 to generate current rectified frame 116. In other words, processing circuitry 104 applies video correction model 106 to current distorted frame 112 to generate current rectified frame 116, and information from one or more previous distorted frames 114 and information from current distorted frame 112 may be inputs to video correction model 106.

Current distorted frame 112 and the one or more previous distorted frames include distortion introduced from one or more cameras 102 that captured current distorted frame 112 and the one or more previous distorted frames. Also, the one or more previous distorted frames are captured before current distorted frame 112.

The information from one or more previous distorted frames 114 may refer to an output from the forward diffusion process (e.g., process in which noise is added) of video correction model 106 when the one or more previous distorted frames were being rectified by video correction model 106. For instance, a first previous distorted frame (e.g., frame captured before current distorted frame 112) was an input to video correction model 106, and was processed through the forward diffusion process of video correction model 106. The result of the forward diffusion process may be a first part of the information from one or more previous distorted frames 114. A second previous distorted frame (e.g., frame captured before current distorted frame 112) was an input to video correction model 106, and was processed through the forward diffusion process of video correction model 106. The result of the forward diffusion process may be a second part of the information from one or more previous distorted frames 114, and so forth. The information from one or more previous distorted frames 114 may be an average (e.g., weighted average) of the result from the forward diffusion process of the one or more previous distorted frames.

The information from one or more previous distorted frames 114 may provide the temporal coherency as part of the reverse diffusion process. That is, the reverse diffusion process of video correction model 106 may be conditioned on information from one or more previous distorted frames 114 to propagate temporal information across frames.

The information from the current distorted frame 112 may refer to extracted feature information of current distorted frame 112. For instance, video correction model 106 may be include a feature encoder unit that is configured to extract feature information from current distorted frame 112. The extracted feature information may be indicative of characteristics of current distorted frame 112 (e.g., labeling color, frequency of particular attribute, etc.).

The information from the current distorted frame 112 may provide spatial coherency as part of the reverse diffusion process. That is, the reverse diffusion process of video correction model 106 may be conditioned on the extracted feature information of current distorted frame 112 to generate spatially coherent rectified output.

Accordingly, in some examples, video correction model 106 may provide spatial and temporal coherency. For instance, video correction model 106 may combine the information from information from one or more previous distorted frames 114 with the information from the current distorted frame 112, and the result further combined with the output of the forward diffusion process on current distorted frame 112 may be inputs into the reverse diffusion process. This enables video correction model 106 to learn spatial and temporal coherence jointly.

In one or more examples, processing circuitry 104 may be configured to determine parameters for video correction model 106, such as weights and offsets for neural network nodes of video correction model 106, based on at least one of a different between current rectified frame 116 and one or more previous rectified frames 118 and a difference between current rectified frame 116 and current distorted frame 112. Processing circuitry 104 may update video correction model 106 based on the parameters. In this way, processing circuitry 104 may enforce temporal consistency between rectified frames and/or enforce spatial consistency between rectified and distorted frames.

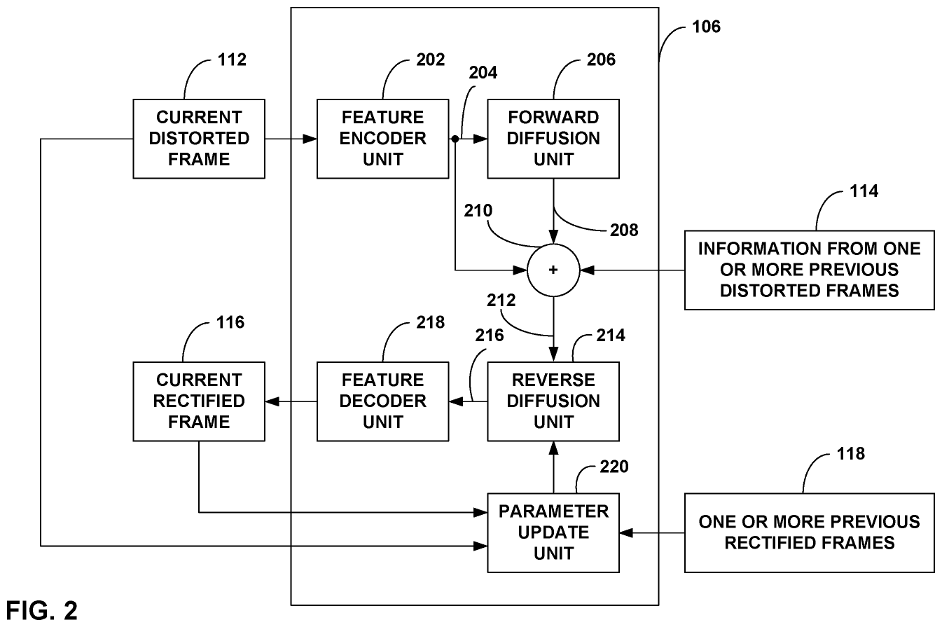

FIG. 2 is a block diagram illustrating an example video correction model. FIG. 2 illustrates video correction model 106 of FIG. 1. The various units of video correction model 106 illustrated in FIG. 2 may be implemented on fixed-function or programmable circuitry of processing circuitry 104.

As illustrated, video correction model 106 includes feature encoder unit 202. Feature encoder unit 202 receives current distorted frame 112 and performs feature extraction. Feature encoder unit 202 may be a ML model configured to generate extracted feature information 204 for current distorted frame 112. The extracted feature information 204 may be indicative of characteristics of current distorted frame 112. Accordingly, processing circuitry 104 may apply a feature encoder to the current distorted frame 112 to generate extracted feature information 204 for the current distorted frame 112, the extracted feature information 204 being indicative of characteristics of the current distorted frame.

For instance, feature encoder unit 202 is responsible for mapping current distorted frame 112 into a lower-dimensional representation or feature space, also called latent space. Feature encoder unit 202 extracts meaningful features from current distorted frame 112 that capture important characteristics or patterns of current distorted frame 112. In convolutional neural network (CNN) architectures, feature encoder unit 202 may include several convolutional layers followed by pooling or downsampling layers, which progressively reduce the spatial dimensions while increasing the number of feature channels. The output of feature encoder unit 202 is extracted feature information 204, which may be considered as a condensed representation of current distorted frame 112, often referred to as a latent space. There may be various ways in which to feature encoder unit 202 may operate to generate extracted feature information 204, and the example techniques are not limited to any particular technique.

Extracted feature information 204 may be the input to the overall diffusion operation of video correction model 106. For instance, forward diffusion unit 206 of video correction model 106 may be configured to perform a forward diffusion process. For example, processing circuitry 104 may apply a forward diffusion process (e.g., via forward diffusion unit 206) to the extracted feature information 204 to generate noisy extracted feature information 208.

As one example, forward diffusion unit 206 may start adding noise over time steps from t=1 to t=T. At each time step, forward diffusion unit 206 may sample noise ∈ₜ=N(0, σₜ²) with increasing noise variance σₜ² over time depending on the noise scheduling. The noise may be Gaussian noise, as an example. The time steps t=1 to t=T are time steps internal to the forward diffusion unit 206, and should not be confused with different times when frames are captured.

Forward diffusion unit 206 continuously adding noise over to each time step of extracted feature information 204 results in noisy extracted feature information 208, which is represented as xₜ. Noisy extracted feature information 208 (e.g., xₜ) is a very noisy version of extracted feature information 204 (e.g., initial latent space of current distorted frame 112). Noisy extracted feature information 208 (e.g., xₜ) can be formulated as: xₜ=sqrt(1−βt))*xₜ₋₁+sqrt(βₜ)*∈ₜ₋₁, where βₜ is the noise scheduling, xₜ₋₁ is noisy extracted feature information 208 at time step t−1, and ∈ₜ₋₁ is the noise added at time step t−1. Accordingly, to apply the forward diffusion process to the extracted feature information 204, processing circuitry 104 (e.g., via forward diffusion unit 206) is configured to add a Gaussian noise over a plurality of time steps to the extracted feature information 204 to generate the noisy extracted feature information 208.

As illustrated, adder 210 of video correction model 106 combines noisy extracted feature information 208 and information from one or more previous distorted frame 114 to generate intermediate information 212. That is, information from one or more previous distorted frame 114 may be input to video correction model 106. In one or more examples, to combine the noisy extracted feature information 208 with the information from the one or more previous distorted frames 114, the processing circuitry 104 is configured to combine the noisy extracted feature information 208 with the information from the one or more previous distorted frames 114 and the extracted feature information 204 for the current distorted frame 112 to generate the intermediate information 212. Reverse diffusion unit 214 receives intermediate information 212 for the reverse diffusion process.

In one or more examples, processing circuitry 104 may be configured to apply noise to one or more previous distorted frames to generate the information from one or more previous distorted frames. For example, the one or more previous distorted frames were previously inputs to feature encoder unit 202, and feature encoder unit 202 generated extracted feature information for the previous distorted frames. Forward diffusion unit 206 then received the extracted feature information for the previous distorted frames, and added noise, as described above, to generate noisy extracted feature information for the previous distorted frames. Information from one or more previous distorted frame 114 may be information based on the noisy extracted feature information for the previous distorted frames.

In one or more examples, by using extracted feature information 204, the reverse diffusion process performed by reverse diffusion unit 214 generates information that feature decoder unit 218 uses to generate current rectified frame 116 which is spatially closer to the input distribution of current distorted frame 112. Adder 210 may directly concatenate extracted feature information 204 with the noisy extracted feature information 208 (e.g., latent space xₜ) and make reverse diffusion unit 214 to implicitly learn to predict current rectified frame 116 spatially similar to current distorted frame 112.

To learn the temporal coherency in between frames, processing circuitry 104 may utilize extracted feature information (e.g., latent spaces) of previous distorted frames. This results in directly injecting temporal information in the denoising process of reverse diffusion unit 214 itself, hence generating current rectified frame 116 not just based on spatial information of noisy extracted feature information 208, but also on the noisy latent spaces of all previous frames (e.g., noisy extracted feature information of one or more previous distorted frames).

In some examples, processing circuitry 104 may determine an average (e.g., weighted average) of all previous predicted latent spaces (e.g., noisy extracted feature information of all previous distorted frames) and not just the noisy extracted feature information of the immediately previous distorted frame to maintain coherency over many frames. This will help increase robustness even if one of the rectified frames is not accurate.

For example, processing circuitry 104 may be configured to generate first extracted feature information for a first previous distorted frame of the one or more previous distorted frames (e.g., via feature encoder unit 202 when the first previous distorted frame was the input). Processing circuitry 104 may be configured to generate second extracted feature information for a second previous distorted frame of the one or more previous distorted frames (e.g., via feature encoder unit 202 when the second previous distorted frame was the input).

Processing circuitry 104 may be configured to apply noise to the first extracted feature information to generate noisy first extracted feature information (e.g., via forward diffusion unit 206 when the first previous distorted frame was the input). Processing circuitry 104 may be configured to apply noise to the second extracted feature information to generate noisy second extracted feature information (e.g., via forward diffusion unit 206 when the second previous distorted frame was the input).

Processing circuitry 104 may generate the information from the one or more previous distorted frames 114 based on the first noisy extracted feature information and the second noisy extracted feature information. For instance, to generate the information from the one or more previous distorted frames, processing circuitry 104 may be configured to determine an average (e.g., weighted average) based on the first noisy extracted feature information and the second noisy extracted feature information. Although a first previous distorted frame and a second previous distorted are described, the example techniques may utilize N number of previous distorted frames.

The following describes example ways in which reverse diffusion unit 214 may utilize the intermediate information 212. For example, processing circuitry 104 may apply a reverse diffusion process (e.g., via reverse diffusion unit 214) on the intermediate information 212 to generate rectified extracted feature information 216.

In the reverse process, reverse diffusion unit 214, which may be a neural network (NN)-based model, learns and predicts from the noisy extracted feature information 204 (e.g., noisy latent xₜ). If NN parameterized model is p_{θ}, then for a small value of βₜ, the probability distribution may be as follows:

p_{θ}(xₜ₋₁|xₜ)=N(xₜ₋₁;μ_{θ}(xₜ,t),Σ_{θ}(xₜ,t))

While some techniques may mostly rely on simplified warping methods for rectification, reverse diffusion unit 214 of video correction model 106 may learn the complex pixel-level corrections and model the pixel-level corrections implicitly through p_{θ}(xₜ₋₁|xₜ). This conditioning distribution helps reverse diffusion unit 214 to implicitly capture complex distortions. By applying this over all the time steps (e.g., (t−1) time steps), reverse diffusion unit 214 can generate rectified extracted feature information 216, which may be similar to but not the exact same as extracted feature information 204. If extracted feature information 204 is represented as X₀, then p_{θ}(X_{0:T})=p_{θ}(x_{T})Πp_{θ}(xₜ₋₁|xₜ).

To make current rectified frame 116 spatially aligned to current distorted frame 112, reverse diffusion unit 214 may condition the above distribution on extracted feature information 204 (represented as τ_{θ}) as well. This will make reverse diffusion unit 214 predict the current rectified frame 116 spatially similar to current distorted frame 112, where p_{θ}(X_{0:T})=p_{θ}(x_{T})Πp_{θ}(xₜ₋₁|xₜ,τ_{θ}).

For the temporal coherency, for video rectification, reverse diffusion unit 214 enforces temporal coherency in by additionally conditioning the reverse process on the latent spaces of all the previous frames (e.g., information from one or more previous distorted frames 114) until current time step {xₜ^{f-1}, xₜ^{f-2} . . . }. By conditioning on information from one or more previous distorted frames, reverse diffusion unit 214 may propagate coherence information directly in the latent space (e.g., directly in rectified extracted feature information 216) during the reverse diffusion process. This forces reverse diffusion unit 214 to correlate the temporal understanding while rectifying successive distorted frames.

If noisy latent (e.g., noisy extracted feature information 208) of current distorted frame 112 is xₜ^{f} and let xₜ^{mean} be the mean of all the previous latent spaces (e.g., information from one or more previous distorted frames 114), then the reverse process can be formulated as follows:

p_{θ}(X_{0:T})=p_{θ}(x_{T}^{f})Πp_{θ}(Xₜ₋₁^{f}|xₜ^{f},τ_{θ}^{f},xₜ^{mean})
where τ_{θ}^{f} is extracted feature information 204 for current distorted frame 112 which was added for spatial coherency
xₜ^{mean}=Σxₜ^{f-i} where ‘i’ varies from 1, 2, . . . (total number of frames−1)

For the first frame, where xₜ^{f_previous} is not available, reverse diffusion unit 214 may only condition on xₜ during the reverse process. The forward process (e.g., via forward diffusion unit 206) corrupts the latent space (e.g., extracted feature information 204) with noise, whereas the reverse process (e.g., via reverse diffusion unit 214) attempts to reconstruct the clean signal from the noisy latent. This helps video correction model 106 to be robust to noise in real-world scenarios.

In some examples, instead of taking the mean of all the previous latent spaces (e.g., mean of all noisy extracted feature information of previous distorted frames) to calculate xₜ^{mean}, processing circuitry 104 may determine a weighted average of the previous latent spaces (e.g., weighted average of noisy extracted feature information of previous distorted frames). This can be done by performing attention based weighted averaging of the latent spaces. The weight ‘w’ can be learned through a simple linear mapping-based attention mechanism.

As illustrated, feature decoder unit 218 receives rectified extracted feature information 216. That is, processing circuitry 104 may apply a feature decoder (e.g., feature decoder unit 218) to the rectified extracted feature information 216 to generate the current rectified frame 116. In one or more examples, feature decoder unit 218 takes the condensed representation (e.g., rectified extracted feature information 216) produced by reverse diffusion unit 214 and generates current rectified frame 116. Feature decoder unit 218 may be a counterpart of feature encoder unit 202, consisting of several layers (often deconvolutional layers or upsampling followed by convolutional layers) that gradually increase the spatial dimensions while reducing the number of feature channels. There may be various ways in which to feature decoder unit 218 may operate to generate current rectified frame 116, and the example techniques are not limited to any particular technique.

In examples where video correction model 106 is a self-supervised model, parameter update unit 220 may be configured to update parameters (e.g., weights and offsets) of reverse diffusion unit 214. As one example, parameter update unit 220 may receive current rectified frame 116 and one or more previous rectified frames 118 (e.g., frames that were previously rectified). Parameter update unit 220 may determine a consistency loss between current rectified frame 116 and one or more previous rectified frames 118 (e.g., difference between current rectified frame 116 and one or more previous rectified frames 118). Parameter update unit 220 may determine parameters that minimize the consistency loss. This will enable reverse diffusion unit 214 to learn coherency between successive frames. Parameter update unit 220 may update video correction model 106 (e.g., reverse diffusion unit 214 of video correction model 106) based on the parameters.

As another example, reverse diffusion unit 214 may learn the coherency between current rectified frame 116 and current distorted frame 112. For instance, parameter update unit 220 may receive current rectified frame 116 and current distorted frame 112. Parameter update unit 220 may determine a consistency loss between current rectified frame 116 and current distorted frame 112 (e.g., difference between current rectified frame 116 and current distorted frame 112). Parameter update unit 220 may determine parameters that minimize the consistency loss. Parameter update unit 220 may update video correction model 106 (e.g., reverse diffusion unit 214 of video correction model 106) based on the parameters.

In some examples, processing circuitry 104 may determine consistency loss based on a difference between current rectified frame 116 and one or more previous rectified frames 118, and minimize the consistency loss with updated parameters. In some examples, processing circuitry 104 may determine consistency loss based on a difference between current rectified frame 116 and current distorted frame 112, and minimize the consistency loss with updated parameters. In some examples, processing circuitry 104 may determine consistency loss based on both a difference between current rectified frame 116 and one or more previous rectified frames 118 and a difference between current rectified frame 116 and current distorted frame 112, and minimize the consistency loss with updated parameters.

For training and updating video correction model 106, processing circuitry 104 may learn the coherency between current rectified frame 116 and current distorted frame 112 by adding the consistency loss between current distorted frame 112 and current rectified frame 116 to video correction model 106 as an input for training. Similarly, processing circuitry 104 may learn the coherency between current rectified frame 116 and one or more previous rectified frames 118 by adding the consistency loss between current distorted frame 112 and one or more previous rectified frames 118 to video correction model 106 as an input for training.

The consistency loss will be less if the semantic representation of the current distorted frame 112 and current rectified frame 116 are similar, and it will be high if the semantic difference are more. Similarly, the consistency loss will be less if the semantic representation of the current distorted frame 112 and one or more previous rectified frames 118 are similar, and it will be high if the semantic difference are more. Thus, the parameters of video correction model 106 will be forced to minimizing this loss hence bringing the semantic features of current distorted frame 112 as close as possible to the current distorted frame 112 or one or more previous rectified frames 118.

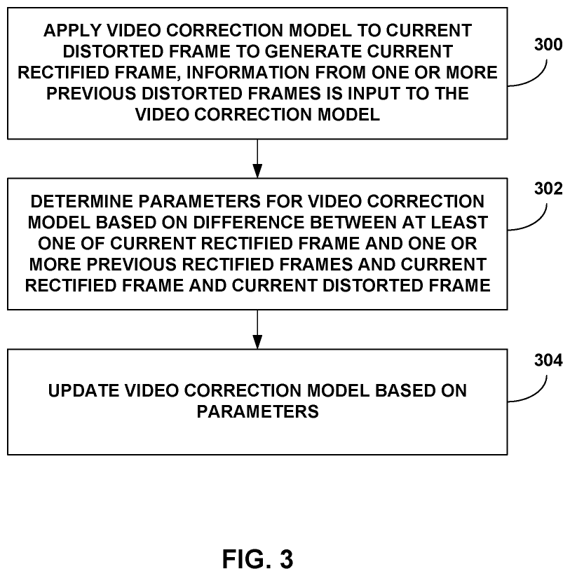

FIG. 3 is a flowchart illustrating an example method of operation. In one or more examples, processing circuitry 104 may apply a video correction model 106 to a current distorted frame 112 to generate a current rectified frame 116, where information from one or more previous distorted frames 114 is input to the video correction model 106 (300). That is, processing circuitry 104 may apply a video correction model 106 to a current distorted frame 112 based on information from one or more previous distorted frames 114 to generate a current rectified frame 116. The current distorted frame 112 and the one or more previous distorted frames include distortion introduced from one or more cameras 102 that captured the current distorted frame and the one or more previous distorted frames. Also, the one or more previous distorted frames are captured before the current distorted frame 112. In one or more examples,

In some examples, the current distorted frame 112 is a current fisheye frame. The one or more previous distorted frames are one or more previous fisheye frames. The one or more cameras 102 are one or more fisheye cameras. As described, fisheye cameras introduce distortion that is present in current distorted frame 112 as well as one or more previous distorted frames.

The processing circuitry 104 may be configured to apply noise to the one or more previous distorted frames to generate the information from one or more previous distorted frames 114. For instance, as part of the forward diffusion process on the extracted feature information of the one or more previous distorted frames, processing circuitry 104 may add noise to the extracted feature information of the one or more previous distorted frames to generate noisy extracted feature information of the one or more previous distorted frames. The noisy extracted feature information of the one or more previous distorted frames, or some average, including weighted average, of the noisy extracted feature information of the one or more previous distorted frames may be considered as the information from one or more previous distorted frames 114.

In some examples, processing circuitry 104 is configured to perform one or more of object detection and object tracking based on the current rectified frame 116. For instance, object detection/tracking unit 108 may perform object detection and/or object tracking for ADAS or XR systems. Object detection and/or object tracking is not necessary in all examples.

Processing circuitry 104 may determine parameters for the video correction model 106 based on at least one of a difference between the current rectified frame 116 and one or more previous rectified frames 118 and a difference between the current rectified frame 116 and the current distorted frame 112 (302). In some examples, processing circuitry 104 (e.g., via parameter update unit 220) may determine the parameters based on the difference between the current rectified frame 116 and the one or more previous rectified frames 118 and the difference between the current rectified frame 116 and the current distorted frame 112. Processing circuitry 104 may be configured to update the video correction model 106 based on the parameters (e.g., via parameter update unit 220) (304).

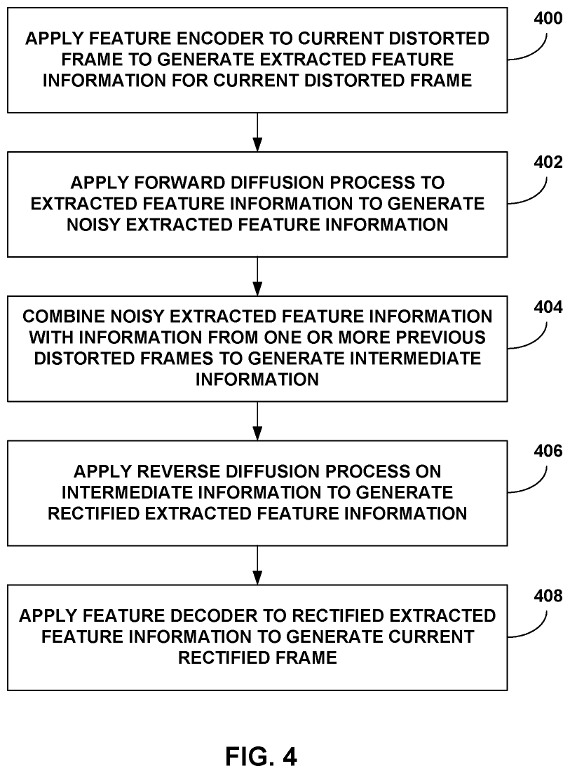

FIG. 4 is a flowchart illustrating another example method of operation. In one or more examples, processing circuitry 104 may apply a feature encoder (e.g., via feature encoder unit 202 of video correction model 106) to the current distorted frame 112 to generate extracted feature information 204 for the current distorted frame 112 (400). The extracted feature information 204 is indicative of characteristics of the current distorted frame 112.

Processing circuitry 104 may apply a forward diffusion process (e.g., via forward diffusion unit 206 of video correction model 106) to the extracted feature information 204 to generate noisy extracted feature information 208 (402). For instance, processing circuitry 104 may be configured to add a Gaussian noise over a plurality of time steps to the extracted feature information 204 to generate the noisy extracted feature information 208.

Processing circuitry 104 may combine (e.g., via adder 210 of video correction model 106) the noisy extracted feature information 208 with the information from the one or more previous distorted frames 114 to generate intermediate information 212 (404). In some examples, to combine the noisy extracted feature information 208 with the information from the one or more previous distorted frames 114, the processing circuitry 104 may be configured to combine the noisy extracted feature information 208 with the information from the one or more previous distorted frames 114 and the extracted feature information 204 for the current distorted frame 112 to generate the intermediate information 212.

As one example, to generate the information from one or more previous distorted frames 114, the processing circuitry 104 may generate first extracted feature information for a first previous distorted frame of the one or more previous distorted frames (e.g., through feature encoder unit 202 when the first previous distorted frame was an input). Processing circuitry 104 may generate second extracted feature information for a second previous distorted frame of the one or more previous distorted frames (e.g., through feature encoder unit 202 when the second previous distorted frame was an input).

Processing circuitry 104 may apply noise to the first extracted feature information (e.g., via forward diffusion unit 206 when the first previous distorted frame was input) to generate noisy first extracted feature information. Processing circuitry 104 may apply noise to the second extracted feature information (e.g., via forward diffusion unit 206 when the second previous distorted frame was input) to generate noisy second extracted feature information.

Processing circuitry 104 may generate the information from the one or more previous distorted frames 114 based on the first noisy extracted feature information and the second noisy extracted feature information. As one example, to generate the information from the one or more previous distorted frames 114, the processing circuitry 104 may be configured to determine an average (e.g., weighted average) based on the first noisy extracted feature information and the second noisy extracted feature information. There may be more than two previous distorted frames, and more than two noisy extracted feature information, and the example techniques are applicable to such examples as well.

Processing circuitry 104 may apply a reverse diffusion process (e.g., via reverse diffusion unit 214) on the intermediate information 212 to generate rectified extracted feature information 216 (406). Processing circuitry 104 may apply a feature decoder (e.g., via feature decoder unit 218) to the rectified extracted feature information 216 to generate the current rectified frame 116.

Various examples of the techniques of this disclosure are summarized in the following clauses:
Clause 1. A system for video rectification, the system comprising: one or more memories; and processing circuitry coupled to the one or more memories and configured to: apply a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame; determine parameters for the video correction model based on at least one of a difference between the current rectified frame and one or more previous rectified frames and a difference between the current rectified frame and the current distorted frame; and update the video correction model based on the parameters.
Clause 2. The system of clause 1, wherein the current distorted frame is a current fisheye frame, the one or more previous distorted frames are one or more previous fisheye frames, and the one or more cameras are one or more fisheye cameras.
Clause 3. The system of any of clauses 1 and 2, wherein the processing circuitry is configured to perform one or more of object detection or object tracking based on the current rectified frame.
Clause 4. The system of any of clauses 1-3, wherein the processing circuitry is configured to apply noise to the one or more previous distorted frames to generate the information from one or more previous distorted frames.
Clause 5. The system of any of clauses 1-4, wherein to apply the video correction model, the processing circuitry is configured to: apply a feature encoder to the current distorted frame to generate extracted feature information for the current distorted frame, the extracted feature information being indicative of characteristics of the current distorted frame; apply a forward diffusion process to the extracted feature information to generate noisy extracted feature information; combine the noisy extracted feature information with the information from the one or more previous distorted frames to generate intermediate information; apply a reverse diffusion process on the intermediate information to generate rectified extracted feature information; and apply a feature decoder to the rectified extracted feature information to generate the current rectified frame.
Clause 6. The system of clause 5, wherein to combine the noisy extracted feature information with the information from the one or more previous distorted frames, the processing circuitry is configured to combine the noisy extracted feature information with the information from the one or more previous distorted frames and the extracted feature information for the current distorted frame to generate the intermediate information.
Clause 7. The system of clause 5, wherein the processing circuitry is configured to: generate first extracted feature information for a first previous distorted frame of the one or more previous distorted frames; generate second extracted feature information for a second previous distorted frame of the one or more previous distorted frames; apply noise to the first extracted feature information to generate noisy first extracted feature information; apply noise to the second extracted feature information to generate noisy second extracted feature information; and generate the information from the one or more previous distorted frames based on the first noisy extracted feature information and the second noisy extracted feature information.
Clause 8. The system of clause 7, wherein to generate the information from the one or more previous distorted frames, the processing circuitry is configured to determine an average based on the first noisy extracted feature information and the second noisy extracted feature information.
Clause 9. The system of any of clauses 5-8, wherein to apply the forward diffusion process to the extracted feature information, the processing circuitry is configured to add a Gaussian noise over a plurality of time steps to the extracted feature information to generate the noisy extracted feature information.
Clause 10. The system of any of clauses 1-9, wherein to determine the parameters for the video correction model, the processing circuitry is configured to determine the parameters based on the difference between the current rectified frame and the one or more previous rectified frames and the difference between the current rectified frame and the current distorted frame.
Clause 11. A method of video rectification, the method comprising: applying a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame; determining parameters for the video correction model based on at least one of a difference between the current rectified frame and one or more previous rectified frames and a difference between the current rectified frame and the current distorted frame; and updating the video correction model based on the parameters.
Clause 12. The method of clause 11, wherein the current distorted frame is a current fisheye frame, the one or more previous distorted frames are one or more previous fisheye frames, and the one or more cameras are one or more fisheye cameras.
Clause 13. The method of any of clauses 11 and 12, further comprising performing one or more of object detection or object tracking based on the current rectified frame.
Clause 14. The method of any of clauses 11-13, further comprising applying noise to the one or more previous distorted frames to generate the information from one or more previous distorted frames.
Clause 15. The method of any of clauses 11-14, wherein applying the video correction model comprises: applying a feature encoder to the current distorted frame to generate extracted feature information for the current distorted frame, the extracted feature information being indicative of characteristics of the current distorted frame; applying a forward diffusion process to the extracted feature information to generate noisy extracted feature information; combining the noisy extracted feature information with the information from the one or more previous distorted frames to generate intermediate information; applying a reverse diffusion process on the intermediate information to generate rectified extracted feature information; and applying a feature decoder to the rectified extracted feature information to generate the current rectified frame.
Clause 16. The method of clause 15, wherein combining the noisy extracted feature information with the information from the one or more previous distorted frames comprises combining the noisy extracted feature information with the information from the one or more previous distorted frames and the extracted feature information for the current distorted frame to generate the intermediate information.
Clause 17. The method of clause 15, further comprising: generating first extracted feature information for a first previous distorted frame of the one or more previous distorted frames; generating second extracted feature information for a second previous distorted frame of the one or more previous distorted frames; applying noise to the first extracted feature information to generate noisy first extracted feature information; applying noise to the second extracted feature information to generate noisy second extracted feature information; and generating the information from the one or more previous distorted frames based on the first noisy extracted feature information and the second noisy extracted feature information.
Clause 18. The method of clause 17, wherein generating the information from the one or more previous distorted frames comprises determining an average based on the first noisy extracted feature information and the second noisy extracted feature information.
Clause 19. The method of any of clauses 15-18, wherein applying the forward diffusion process to the extracted feature information comprises adding a Gaussian noise over a plurality of time steps to the extracted feature information to generate the noisy extracted feature information.
Clause 20. A computer-readable storage medium storing instructions thereon that when executed cause one or more processors to: apply a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame; determine parameters for the video correction model based on at least one of a difference between the current rectified frame and one or more previous rectified frames and a difference between the current rectified frame and the current distorted frame; and update the video correction model based on the parameters.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A system for video rectification, the system comprising:
one or more memories; and
processing circuitry coupled to the one or more memories and configured to:
apply a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame;
determine parameters for the video correction model based on at least one of a difference between the current rectified frame and one or more previous rectified frames and a difference between the current rectified frame and the current distorted frame; and
update the video correction model based on the parameters.

2. The system of claim 1, wherein the current distorted frame is a current fisheye frame, the one or more previous distorted frames are one or more previous fisheye frames, and the one or more cameras are one or more fisheye cameras.

3. The system of claim 1, wherein the processing circuitry is configured to perform one or more of object detection or object tracking based on the current rectified frame.

4. The system of claim 1, wherein the processing circuitry is configured to apply noise to the one or more previous distorted frames to generate the information from one or more previous distorted frames.

5. The system of claim 1, wherein to apply the video correction model, the processing circuitry is configured to:
apply a feature encoder to the current distorted frame to generate extracted feature information for the current distorted frame, the extracted feature information being indicative of characteristics of the current distorted frame;
apply a forward diffusion process to the extracted feature information to generate noisy extracted feature information;
combine the noisy extracted feature information with the information from the one or more previous distorted frames to generate intermediate information;
apply a reverse diffusion process on the intermediate information to generate rectified extracted feature information; and
apply a feature decoder to the rectified extracted feature information to generate the current rectified frame.

6. The system of claim 5, wherein to combine the noisy extracted feature information with the information from the one or more previous distorted frames, the processing circuitry is configured to combine the noisy extracted feature information with the information from the one or more previous distorted frames and the extracted feature information for the current distorted frame to generate the intermediate information.

7. The system of claim 5, wherein the processing circuitry is configured to:
generate first extracted feature information for a first previous distorted frame of the one or more previous distorted frames;
generate second extracted feature information for a second previous distorted frame of the one or more previous distorted frames;
apply noise to the first extracted feature information to generate noisy first extracted feature information;
apply noise to the second extracted feature information to generate noisy second extracted feature information; and
generate the information from the one or more previous distorted frames based on the first noisy extracted feature information and the second noisy extracted feature information.

8. The system of claim 7, wherein to generate the information from the one or more previous distorted frames, the processing circuitry is configured to determine an average based on the first noisy extracted feature information and the second noisy extracted feature information.

9. The system of claim 5, wherein to apply the forward diffusion process to the extracted feature information, the processing circuitry is configured to add a Gaussian noise over a plurality of time steps to the extracted feature information to generate the noisy extracted feature information.

10. The system of claim 1, wherein to determine the parameters for the video correction model, the processing circuitry is configured to determine the parameters based on the difference between the current rectified frame and the one or more previous rectified frames and the difference between the current rectified frame and the current distorted frame.

11. A method of video rectification, the method comprising:
applying a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame;
determining parameters for the video correction model based on at least one of a difference between the current rectified frame and one or more previous rectified frames and a difference between the current rectified frame and the current distorted frame; and
updating the video correction model based on the parameters.

12. The method of claim 11, wherein the current distorted frame is a current fisheye frame, the one or more previous distorted frames are one or more previous fisheye frames, and the one or more cameras are one or more fisheye cameras.

13. The method of claim 11, further comprising performing one or more of object detection or object tracking based on the current rectified frame.

14. The method of claim 11, further comprising applying noise to the one or more previous distorted frames to generate the information from one or more previous distorted frames.

15. The method of claim 11, wherein applying the video correction model comprises:
applying a feature encoder to the current distorted frame to generate extracted feature information for the current distorted frame, the extracted feature information being indicative of characteristics of the current distorted frame;
applying a forward diffusion process to the extracted feature information to generate noisy extracted feature information;
combining the noisy extracted feature information with the information from the one or more previous distorted frames to generate intermediate information;
applying a reverse diffusion process on the intermediate information to generate rectified extracted feature information; and
applying a feature decoder to the rectified extracted feature information to generate the current rectified frame.

16. The method of claim 15, wherein combining the noisy extracted feature information with the information from the one or more previous distorted frames comprises combining the noisy extracted feature information with the information from the one or more previous distorted frames and the extracted feature information for the current distorted frame to generate the intermediate information.

17. The method of claim 15, further comprising:
generating first extracted feature information for a first previous distorted frame of the one or more previous distorted frames;
generating second extracted feature information for a second previous distorted frame of the one or more previous distorted frames;
applying noise to the first extracted feature information to generate noisy first extracted feature information;
applying noise to the second extracted feature information to generate noisy second extracted feature information; and
generating the information from the one or more previous distorted frames based on the first noisy extracted feature information and the second noisy extracted feature information.

18. The method of claim 17, wherein generating the information from the one or more previous distorted frames comprises determining an average based on the first noisy extracted feature information and the second noisy extracted feature information.

19. The method of claim 15, wherein applying the forward diffusion process to the extracted feature information comprises adding a Gaussian noise over a plurality of time steps to the extracted feature information to generate the noisy extracted feature information.

20. A computer-readable storage medium storing instructions thereon that when executed cause one or more processors to:
apply a video correction model to a current distorted frame to generate a current rectified frame, wherein information from one or more previous distorted frames is input to the video correction model, wherein the current distorted frame and the one or more previous distorted frames include distortion introduced from one or more cameras that captured the current distorted frame and the one or more previous distorted frames, and wherein the one or more previous distorted frames are captured before the current distorted frame;
determine parameters for the video correction model based on at least one of a difference between the current rectified frame and one or more previous rectified frames and a difference between the current rectified frame and the current distorted frame; and
update the video correction model based on the parameters.
